(19) United States
(12) Patent Application Publication
(10) Pub. No.: US 2015/0007718 A1
(43) Pub. Date: Jan. 8, 2015

(54) HYDRAULIC ACTUATOR SYSTEM AND APPARATUS

(71) Applicant: ZP Interests, LLC, Houston, TX (US)

(72) Inventors: Hernani G. DeOcampo, Spring, TX (US); Robert Y. Jones, Houston, TX (US)

(73) Assignee: ZP Interests, LLC

(21) Appl. No.: 13/934,498

(22) Filed: Jul. 3, 2013

(51) Int. Cl. F15B 15/14

(52) U.S. Cl. CPC F15B 15/14
USPC 92/174

(57) ABSTRACT

A hydraulic actuator apparatus includes a hydraulic cylinder having a top and bottom face wherein a rotatable piston is movably disposed. Top and bottom pistons rods that are rotatably removable and couple to the top and bottom faces of the piston. The piston rods are interchangeable so that the top piston rod can be exchanged with the bottom piston rod. The hydraulic actuator apparatus further includes top and bottom end caps, which sealably couple to the top and bottom faces of the hydraulic cylinder, and the end caps support connection to external components and have thru holes, which allow their respective piston rods to emerge from the hydraulic cylinder. The end caps are also interchangeable so that the top end cap and the bottom end cap can be switched. The hydraulic actuator apparatus is symmetric and can be rotated with respect to its connection to external components.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

This invention generally relates to hydraulic actuators used for transforming pressurized hydraulic fluid to motion. In particular, this invention relates to hydraulic actuators that are symmetrical and having minimal directionality so internal parts are rotatable and interchangeable and so that both ends of the hydraulic actuator can be interchangeably used to couple to an external component to be moved by the hydraulic actuator.

2. Description of Related Art

Hydraulic actuators are commonly used to convert hydraulic fluid pressure supplied from an external source to controlled motion. An external source such as a pump pressurizes hydraulic fluid. This pressurized hydraulic fluid is subsequently used to supply the force to move parts within the hydraulic actuator.

A hydraulic actuator typically consists of a cylinder, which is capable of withstanding the pressure of the hydraulic fluid. This cylinder has an inner chamber whose surface is smoothly finished. The cylinder is sealed with end caps so that hydraulic fluid used in the operation of the cylinder does not leak outside the cylinder and hydraulic pressure can build up within its inner chamber. A machined piston is disposed within the hydraulic cylinder's chamber and separates pressurized zones within the chamber. The piston is moveable within the inner chamber. A piston rod typically attached with threads bolts or nuts to the piston and passes through a seal portion of the end cap and transfers any motion of the piston within the chamber to any item coupled to the piston rod.

Hydraulic fluid is brought to the hydraulic actuator by a feed line coupled to a port on the hydraulic actuator. The hydraulic fluid enters the inner chamber of at least one zone of the piston. In a single acting hydraulic actuator, the hydraulic fluid enters only one zone of the chamber divided by the piston. As the pressurized hydraulic fluid enters that zone of the chamber, the force within the zone increases, pushing the piston and correspondingly moving the piston rod and any external component connected to the piston rod. By decreasing or removing the pressurized hydraulic fluid, the force within the zone decreases and the piston returns to its restored position. A counter force such as an internal spring or gravity acts to move the piston and piston rod back to its original position. In a double acting hydraulic actuator, the hydraulic fluid enters a second zone and acts equivalent to a counter force to move the piston back to a restored position.

Often, hydraulic actuators are installed in locations where it can be difficult to remove the complete actuator from the external component for servicing. Alternatively, removal and shipment of the actuator to a service location can result in prohibitively long downtimes. As a result, it is beneficial to service these actuator in the field. Often these hydraulic actuators can be serviced by those having little training in actuator repair and replacement. If the hydraulic actuator is reassembled improperly, the actuator can be damaged or may not function at all.

Thus, there is a need for a hydraulic actuator having easy and straightforward assembly or reassembly. This is accomplished by having a actuator design where actuator components are as non-directional as possible and where similar parts are interchangeable. Symmetrical components are useful for such a design. With a symmetrical piston design, a person servicing the actuator does not have to consider whether the piston is facing the proper direction within the chamber—either way will work. Further, a symmetric actuator allows for non-directional installation to external components. Also, interchangeable parts reduce the risk of improper installation or reassembly.

Further, actuator parts are subject to wear and inventory must be kept of replacement parts. As the number of distinct parts in an actuator decreases, the number of parts that must be kept as inventory also decreases. Thus interchangable parts also have the additional benefit that fewer inventory have to be kept in anticipation of a needed in field replacement. Increasing interchangeability is also beneficial for the manufacturers of hydraulic actuators who have to source less numbers of components and require less inventory.

### SUMMARY OF THE INVENTION

In accordance with the teachings provided herein for hydraulic actuators, one example provides a hydraulic actuator apparatus. The apparatus comprises an actuator body having an axial sleeve bore, wherein the actuator body has a first end and a second end. The apparatus further comprises a piston operationally disposed within the axial sleeve bore, wherein the piston has a first piston surface and a second piston surface that are substantially identical in shape and configuration such that the piston can be configured within the axial sleeve bore with the first piston surface facing either the first end or the second end of the actuator body. The apparatus further comprises a first end cap having a first end cap hole defined therein where the first end cap is removably coupled to either the first end or the second end of the actuator body. The apparatus further comprises a second end cap removably coupled to the actuator body on an end opposite of the first end cap. The apparatus further comprises a piston rod disposed in the first chamber and having a piston rod end removably coupled to either the first piston surface or second piston surface wherein the piston rod slidably traverses through the first end cap hole.

In another example, a hydraulic actuator apparatus is provided comprising an actuator body having an axial sleeve bore, wherein the actuator body has a first end and a second end and a piston operationally disposed within the axial sleeve bore, wherein the piston has a first piston surface, a second piston surface, and a piston engaging face wherein the piston engaging face is in circumferential and contiguous engagement with the circumference of the axial sleeve bore to form a first chamber and a second chamber within the axial sleeve bore. The apparatus further comprises a first end cap having a first end cap hole defined therein, the first end cap being removably coupled to the first end of the actuator body and a second end cap removably coupled to the second end of the actuator body. The apparatus further comprises a piston rod disposed in the first chamber removably coupled to the first piston surface and slidably traversable through the first end cap hole, wherein the piston rod can be removed from the first chamber and decoupled from the first piston surface and placed within the second chamber and removably coupled to the second piston surface.

In another example, a hydraulic actuator system is provided comprising a hydraulic actuator apparatus and an external component. The hydraulic actuator apparatus comprises an actuator body having an axial sleeve bore, wherein the actuator body has a first end and a second end, a first end cap having a first end cap hole defined therein and removably coupled to the first end of the actuator body, and a second end cap having a second end cap hole defined therein and removably coupled to the second end of the actuator body. The hydraulic actuator apparatus further comprises a piston operationally and removably disposed within the axial sleeve bore, wherein the piston has a first piston surface and a second piston surface, wherein the piston divides the axial sleeve bore into a first chamber and a second chamber, a first piston rod removably coupled to the first piston surface and slidably traversable through the first end cap hole, and a second piston rod removably coupled to the second piston surface and slidably traversable through the second end cap hole. The external component is removably coupled to the first end cap engaged with and removably coupled to the first piston rod, wherein the external component can be decoupled from the first end cap and first piston rod and removably coupled to the second end cap and removably coupled to the second piston rod.

### BRIEF DESCRIPTION OF THE SEVERAL VIEWS OF THE DRAWINGS

The foregoing summary, as well as the following detailed description, will be better understood when read in conjunction with the appended drawings. For the purpose of illustration, certain embodiments of the present disclosure are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present invention and, together with the description, serve to explain advantages and principles consistent with the invention.

FIG. 1 illustrates a side view of one embodiment of a hydraulic actuator connected to an external adapter;

FIG. 2 illustrates a cross-sectional view of one embodiment of the hydraulic actuator connected to an external adapter;

FIG. 3a illustrates a detailed side view of a piston as it is attached to a piston rod used within the hydraulic actuator according to one embodiment of this invention; and

FIG. 3b illustrates a detailed side view of the piston as it is attached to the piston rod used within the hydraulic actuator rotated ninety (90) degrees about a vertical axis in relation to FIG. 3a and according to one embodiment of the invention.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The Figures and written description are provided to teach any person skilled in the art to make and use the inventions for which patent protection is sought. The invention is capable of other embodiments and of being practiced and carried out in various ways. Those skilled in the art will appreciate that not all features of a commercial embodiment are shown for the sake of clarity and understanding. Persons of skill in the art will also appreciate that the development of an actual commercial embodiment incorporating aspects of the present inventions will require numerous implementation—specific decisions to achieve the developer's ultimate goal for the commercial embodiment. While these efforts can be complex and time-consuming, these efforts nevertheless would be a routine undertaking for those of skill in the art having the benefit of this disclosure.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity in specific reference to the Figures and are not intended to limit the scope of the invention or the appended claims. Further, it should be understood that any one of the features of the invention can be used separately or in combination with other features. Other systems, methods, features, and advantages of the invention will be or become apparent to one with skill in the art upon examination of the Figures and the detailed description. It is intended that all such additional systems, methods, features, and advantages be included within this description, be within the scope of the present invention, and be protected by the accompanying claims.

Reference will now be made in detail to an implementation consistent with the present invention as illustrated in the accompanying drawings. For the purpose of clarification, embodiments described herein reference the term “fluid,” which refers to a gas, liquid, as well as liquid solution with solid aggregates, as well as any material that can reasonably be expected to flow.

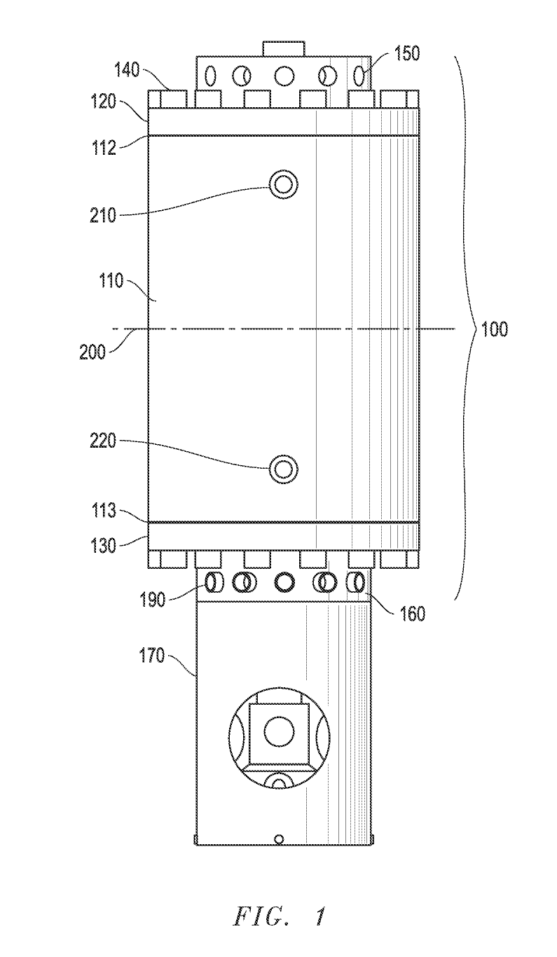

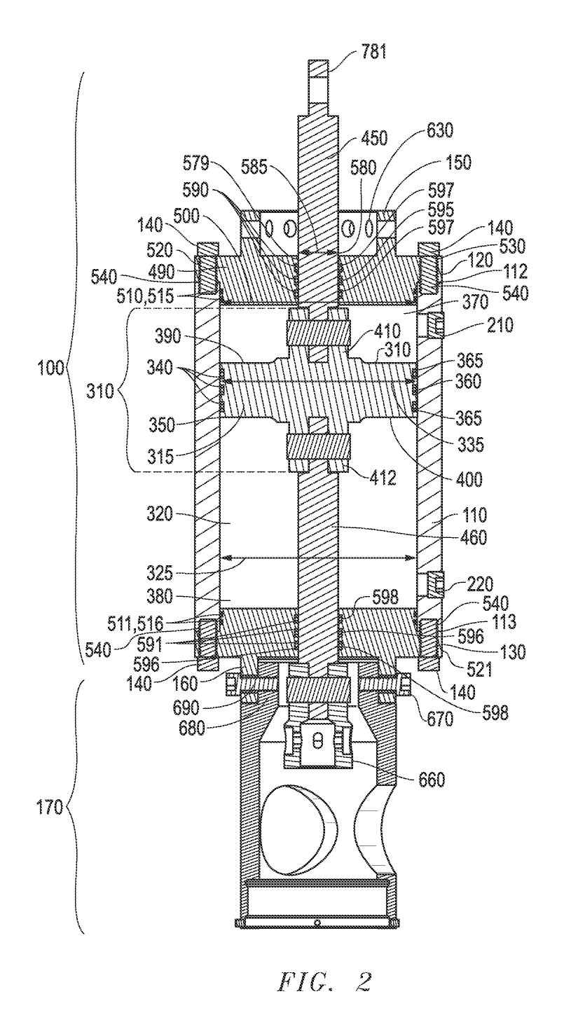

Referring to FIG. 1, by way of non-limiting example, and consistent with embodiments of the invention, a hydraulic actuator assembly 100 is shown. The hydraulic actuator assembly 100 includes a hydraulic chamber 110 having a bore (shown in FIG. 2 as bore 320). The hydraulic actuator assembly 100 further consists of a top end cap 120 and a bottom end cap 130 which sealably engage with the hydraulic chamber 110. The top end cap 120 couples to a top face 112 of the hydraulic chamber 110. The top end cap 120 is substantially similar to the bottom end cap 130. The bottom end cap 130 connects to a bottom face 113 of the hydraulic chamber 110. Actuator bolts 140 traverse the top end cap 120 and the bottom end cap 130 and threadably engage with the hydraulic chamber 110 to retain the top end cap 120 and the bottom end cap 130 on the hydraulic chamber 110.

The hydraulic actuator assembly 100, which converts pressure to controlled motion, typically connects to an external component (not shown) that requires the motion as part of its function. The bottom end cap 130 incorporates a bottom mating connection 160 that attaches to a coupling connection 170 through coupling bolts 190. The top end cap 120 incorporates a top mating connection 150 that is substantially similar to the bottom mating connection 160. In this way either the top end cap 120 of the hydraulic actuator assembly 100 or the bottom end cap 130 can connect to the external component (not shown) directly or through the coupling connection 170. Because the top end cap 120 is substantially similar to the bottom end cap 130, the coupling connection 170 can connect to the top end cap 120.

The hydraulic chamber 110 of the hydraulic actuator assembly incorporates a top hydraulic port 210 and a bottom hydraulic port 220. The top hydraulic port 210 couples to a first portion of a bore 320 (not visible in FIG. 1 but shown in FIG. 2) of the hydraulic chamber 110 while the bottom hydraulic port 220 couples to the bottom portion of the bore 320 (not visible in FIG. 1 but shown in FIG. 2) of the hydraulic chamber 110.

The hydraulic chamber 110 is symmetric about a plane 200 shown as bisecting the hydraulic actuator assembly 100. The plane 200 is depicted for reference purposes only and is not a physical element of the hydraulic actuator assembly 100. Because the top end cap 120 and the bottom end cap 130 are substantially similar, the hydraulic chamber 110 coupled with the top end cap 120 and the bottom end cap 130 are symmetric about the plane 200. The hydraulic actuator assembly 100 is symmetric and as a result, can be rotated such that the top end cap 120 is facing down while the bottom end cap 130 is facing upwards and capable to couple to an external assembly (not shown) without substantial modification. Further, the top hydraulic port 210 and the bottom hydraulic port 220 can be of substantially similar connection type and can be located at positions that are substantially mirrored across the plane 200. This allows the hydraulic actuator assembly 100 to be rotated within its surroundings with minimal adjustment of any feed lines (not shown) that connect to the top hydraulic port 210 and bottom hydraulic port 220.

One of skill in the art will understand that other symmetrical arrangements would also permit the hydraulic actuator assembly 100 to be rotated in its external coupling from top to bottom. For example, the top hydraulic port 210 and the bottom hydraulic port 220 can be rotated 180 degrees with respect to each other so that the top hydraulic port 210 is on the left and the bottom port is on the right of FIG. 1. Such an arrangement would also allow the hydraulic actuator assembly 100 to be rotated top to bottom in it external coupling, and the top end cap 120 and the bottom end cap 130 remain symmetric across the plane 200.

As will be described, the hydraulic actuator assembly 100 incorporates a piston assembly 310 (not visible in FIG. 1 but shown in FIG. 2) that is movable within the hydraulic chamber 110. The piston assembly 310 couples to an external component (not shown) which makes use of the force-to-motion transformation of the hydraulic actuator assembly 100. The coupling connection 170 provides a means to attach the hydraulic actuator assembly 100 to the external component (not shown). One non-limiting example of an external component with which the hydraulic actuator assembly 100 can be used is a gate valve (not shown). The motion in the piston assembly 310 (shown in FIG. 2) can be used to translate a gate (not shown) within the gate valve's body (not shown). As will be recognized by one of skill in the art, if the external component (not shown) and the top mating connection 150 or bottom mating connection 160 are designed such that they are compatible, i.e., they will mate together, a coupling connection 170 is not necessary and the hydraulic actuator assembly 100 can mate directly with the external component (not shown). Since the hydraulic actuator assembly 100 is designed so that the top mating connection 150 on the top end cap 120 or the bottom mating connection 160 on the bottom end cap 130 are substantially similar, the external component (not shown) can be easily attached to either the top mating connection 150 or bottom mating connection 160.

Referring now to FIG. 2 showing a cross section of the hydraulic actuator assembly 100, the components and operation of the hydraulic actuator assembly 100 will be described. The piston assembly 310, previously mentioned, is operationally disposed within a bore 320 of the hydraulic chamber 110. The bore 320 has a bore diameter 325 that is substantially constant throughout the hydraulic chamber 110. The piston assembly 310 comprises a piston plate 315 that is formed and having a piston diameter 335 that is substantially equal to but slightly smaller than the bore diameter 325 so that the piston assembly 310 is able to move within the hydraulic chamber 110. The piston plate 315 has an engaging face 350 that couples with the inner surface of the hydraulic chamber 110. Three piston grooves 340 are formed on the engaging face 350 of the piston plate 315. Piston seals 365 are disposed within a piston groove 340 that is disposed centrally within the engaging face 350 and the piston seals 365 compressively engages with the inner surface of the hydraulic chamber 110 to provide a seal and thereby separate the bore 320 of the hydraulic chamber 110 into an upper bore 370 and a lower bore 380. The piston seals 365 maintain fluidic integrity so that the passage of hydraulic fluid between the upper bore 370 and the lower bore 380 is restricted. As a non-limiting example, the piston seals 365 can be an elastomeric O-ring. In addition, in order to prevent a metal-to-metal contact between the piston assembly 310 and the hydraulic chamber 110, a bushing 360 is disposed in the piston grooves 340 not contain the piston seals 365. As a non-limiting example, the bushing 360 can be made from material such as polytetrafluoroethylene (PTFE). One of skill in the art will also recognize that multiple piston grooves 340 with piston seals 365 and bushing 360 are not necessary to separate the hydraulic chamber 110 into an upper bore 370 and a lower bore 380 and that this can be accomplished with only one piston groove 340 and one piston seal 365 if a second piston seal 365 and bushing 360 are not required.

The piston plate 315 of the piston assembly 310 includes a piston top surface 390 and a piston bottom surface 400 that are substantially identical. The piston assembly 310 further comprises a top lug portion 410 attached to the piston plate 315 at the piston top surface 390 and a bottom lug portion 412 at the piston bottom surface 400. A top piston rod 450 couples to the piston top surface 390 at the top lug portion 410. Similarly, a bottom piston rod 460 couples to the piston bottom surface 400 at the bottom lug portion 412 on the piston bottom surface 400. The top lug portion 410 is substantially similar to the bottom lug portion 412. The top piston rod 450 is substantially similar to the bottom piston rod 460 so that the top piston rod 450 can be interchanged with the bottom piston rod 460. Further details on coupling the top piston rod 450 and bottom piston rod 460 to the piston assembly 310 are described below. One of skill in the art will understand that both the top piston rod 450 and the bottom piston rod 460 need not be necessary for a particular configuration. For example, if a use situation arises wherein the hydraulic actuator assembly 100 is only being engaged from one side, only one piston rod, either the top piston rod 450 or the bottom piston rod 460 is necessary. In this situation, the top piston rod 450 can be coupled to the piston bottom surface 400 either by rotating the piston assembly 310 within the hydraulic chamber 110 or by disposing the top piston rod 450 within the lower bore 380. One of skill in the art will recognize that the length of hydraulic chamber 110 is determined by the length of travel required of the top piston rod 450 and bottom piston rod 460.

The top end cap 120 couples to the top face 112 of the hydraulic chamber 110. The top end cap 120 comprises a lower end cap portion 490 having an end cap outer diameter 500 substantially equal to but slightly smaller than the bore diameter 325 of the hydraulic chamber 110. The lower end cap portion 490 of the top end cap 120 incorporates top end cap grooves 510 on the outer surface of the lower end cap portion 490 wherein top end cap seals 515 are disposed within the top end cap grooves 510. The top end cap seal 515 compressively engages with the inner surface of the hydraulic chamber 110 to provide a fluidic seal to thereby maintain fluidic integrity within the hydraulic chamber 110 such that hydraulic fluid within the upper bore 370 of the hydraulic chamber 110 cannot pass outside the chamber where the top end cap 120 meets the hydraulic chamber 110, to enable hydraulic pressure to increase within the upper bore 370. As a non-limiting example, the top end cap seal 515 can be an elastomeric O-ring. One of skill in the art will recognize that multiple top end cap grooves 510 with top end cap seals 515 can be used but are not necessary to isolate the upper bore 370 of the hydraulic chamber 110 and that this can be accomplished with only one top end cap groove 510 and one top end cap seal 515.

The top end cap 120 further comprises a top end cap lip 520 which overlays the top face 112 of the hydraulic chamber 110. The top end cap lip 520 incorporates end cap thru holes 530, which allow threaded actuator bolts 140 to pass thorough and threadingly couple within complementary threaded holes 540 in the top face 112 of the hydraulic chamber 110. The thru holes 530, threaded actuator bolts 140, and complementary threaded holes 540 are used around the diameter of the hydraulic chamber and the top end cap 120 to removably fasten the top end cap 120 onto the hydraulic chamber 110.

The top end cap 120 also comprises a top end cap central hole 580 having a end cap hole diameter 585 that is substantially equal but slightly larger than the outer diameter of the top piston rod 450 so that the top piston rod 450 can pass through and travel within the top end cap central hole 580. The top piston rod 450 passes outside of the remaining hydraulic actuator assembly 100 and through the top end cap 120 to engage with external components (not shown). The top end cap 120 also comprises top end cap hole grooves 590 long the central hole wall 579 at the outer diameter of the top end cap central hole 580. Top central hole seal 597 are disposed within the top end cap hole grooves 590 and along the central hole wall 579 at the end cap hole diameter 585 of the top end cap central hole 580. A top central hole bushing 595 is disposed in the top end cap hole grooves 590 where the top central hole seals 597 are not present to prevent metal-to-metal contact between the top end cap 120 and the top piston rod 450. As the top piston rod 450 passes through the top end cap central hole 580, it compressively engages with the top central hole seals 597 to provide a seal and thereby maintains fluidic integrity within the hydraulic chamber 110 such that hydraulic fluid within the hydraulic chamber 110 cannot pass outside the upper bore 370 where the top piston rod 450 meets the top end cap 120, and hydraulic pressure can increase within the upper bore 370. As a non-limiting example, the top central hole bushing 595 can be fabricated from PTFE and the top central hole seal 597 can be an elastomeric O-ring.

The top end cap 120 also comprises a top mating connection 150 for coupling to external components (not shown). The top mating connection 150 comprises ring thru holes 630 through which bolts (not shown) can be used to affix the hydraulic actuator assembly 100 onto an external component (not shown).

The bottom end cap 130 is substantially similar in structure and function to the top end cap 120. In a substantially similar manner as regarding the top end cap 120, the bottom end cap 130 can couple to the bottom surface of the hydraulic chamber 110. The bottom end cap 130 is substantially similar to the top end cap 120 and also comprises a bottom end cap groove 511 accommodating bottom end cap seals 516 to seal the lower bore 380 where the bottom end cap 130 meets the hydraulic chamber 110. Further, the bottom end cap 130 also comprises a bottom end cap lip 521 which overlays the bottom face 113 of the hydraulic chamber 110. The bottom end cap lip 521 incorporates bottom end cap thru holes 531, which allow the threaded actuator bolts 140 to pass through and threadingly couple with complementary bottom threaded holes 541 in the bottom face 113 of the hydraulic chamber 110. Further, the bottom end cap 130 also comprises a bottom end cap central hole 581 that accommodates the bottom piston rod 460 so that the bottom piston rod 460 can pass through the bottom end cap 130. Bottom central hole seals 598 are disposed in the bottom central hole groove 591 and compressively engages with the bottom piston rod 460 to seal the lower bore 380 where the bottom piston rod 460 meets the bottom end cap 130. And substantially similar to the top end cap 120, the bottom central hole bushing 596 is disposed in the bottom central hole grooves 591 where the bottom central hole seals 598 are not present to prevent metal-to-metal contact between the top end cap 120 and the top piston rod 450. The material for the bottom central hole seals 598 and bottom central hole bushing 596 can be the same as that for the top central hole seals 597 and top central hole bushing 595, respectively.

The bottom end cap 130 couples to a coupling connection 170 or an external component (not shown but connecting in substantially the same way as the coupling connection 170) through the bottom mating connection 160 which is substantially similar to the top mating connection 150. The bottom mating connection 160 couples to a complementary ring 680 on the external component having component engagement holes 690. Coupling bolts 190 traverse the ring thru holes 630 and threadingly engage with the component engagement holes 690 to secure the hydraulic actuator assembly 100 via its bottom end cap 130 to the coupling connection 170. Further, the bottom piston rod 460 engages with the coupling connection 170 or an external component (not shown) through an external piston attachment 660 which can be secured to the bottom piston rod 460 through a pin and lug assembly similar to that described in coupling the bottom piston rod 460 to the piston bottom surface 400 of the piston assembly 310. By coupling the bottom piston rod 460 to the external component (not shown), any movement in the piston assembly 310 within the hydraulic chamber 110 relative to the bottom end cap 130 will result in a similar movement in portions of the external component (not shown) connected to the bottom piston rod 460.

In the described embodiment of the hydraulic actuator assembly 100, the hydraulic chamber 110 has a top hydraulic port 210 and a bottom hydraulic port 220 that allows connection of hydraulic fluid hose connections (not shown) to the hydraulic actuator assembly 100. The top hydraulic port 210 provides a connection to a bore through the wall of the hydraulic chamber 110 so that hydraulic fluid can pass through the wall of the hydraulic chamber 110 and fill the upper bore 370. In a substantially similar manner, the bottom hydraulic port 220 allows hydraulic fluid to fill the lower bore 380. When hydraulic fluid is forced into the upper bore 370, the fluidic force will cause the piston assembly 310 to translate downward within the hydraulic chamber 110. Similarly, when hydraulic fluid is forced into the lower bore 380, fluidic force will cause the piston assembly 310 to translate upward within the hydraulic chamber 110. The top piston rod 450 and bottom piston rod 460 attached to the piston assembly 310 move with the piston assembly 310 and translate through the top end cap 120 and the bottom end cap 130 respectively. One of skill in the art will recognize that in a single acting actuator, a single hydraulic port, either the top hydraulic port 210 or the bottom hydraulic port 220, can be utilized whereby hydraulic force can move the piston assembly 310 in one direction while an inner spring (not shown) or gravity can supply the force to move the piston assembly 310 in the opposite direction.

The bottom end cap 130 is substantially similar to the top end cap 120; the top face 112 of the hydraulic chamber 110 is substantially similar to the bottom face 113 of the hydraulic chamber 110; the piston top surface 390 is substantially similar to the piston bottom surface 400; and the top piston rod 450 is substantially similar to the bottom piston rod 460. As a result, the bottom end cap 130 is functionally interchangeable with the top end cap 120. When the bottom end cap 130 is exchanged with the top end cap 120, the bottom end cap 130 will functionally couple with the top face 112 of the hydraulic chamber 110. The top piston rod 450 will functionally engage with the bottom end cap 130. Further any external components (not shown) engaging with the top end cap 120 can functionally engage with the bottom end cap 130 and any external components (not shown) engaging with the bottom end cap 130 can functionally engage with the top end cap 120. Similarly, the top end cap 120 can couple with the bottom face 113 of the hydraulic chamber 110 and with the bottom piston rod 460 and engage with any external circuitry (not shown) that originally coupled to the bottom end cap 130.

In one embodiment of the hydraulic actuator 100, a typical length of the hydraulic chamber 110 is nineteen (19) inches. For this embodiment, outer diameter (not shown) of the hydraulic chamber is twelve and one-half (12.5) inches. The bore diameter 325 is ten (10) inches. The piston diameter 335 is slightly smaller than the bore diameter 325. The thickness of the piston plate 315 is two and three-quarters (2.75) inches. The length of the top piston rod 450 is substantially the same as the bottom piston rod 460 and is fifteen and one-quarter (15.25) inches. Dimensions of other portions and components of the actuator in this embodiment complement these dimensions and can be determined by one of skill in the art. One of skill in the art will also recognize that this embodiment is not limited to any particular size and the dimensions the hydraulic actuator 100 and its components of will depend upon the particular application for which it is employed.

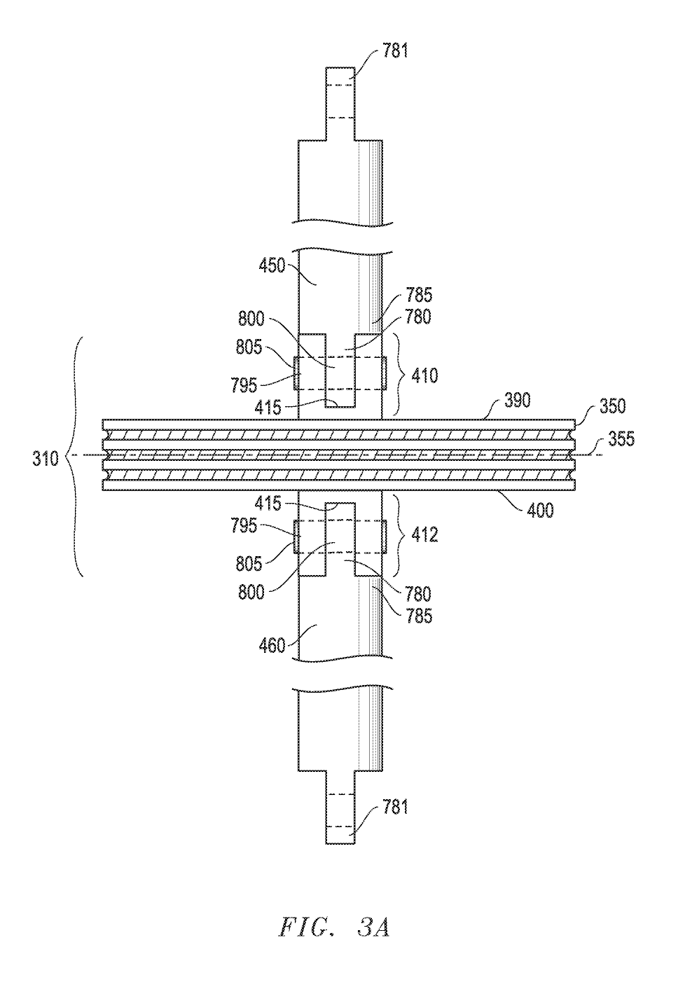

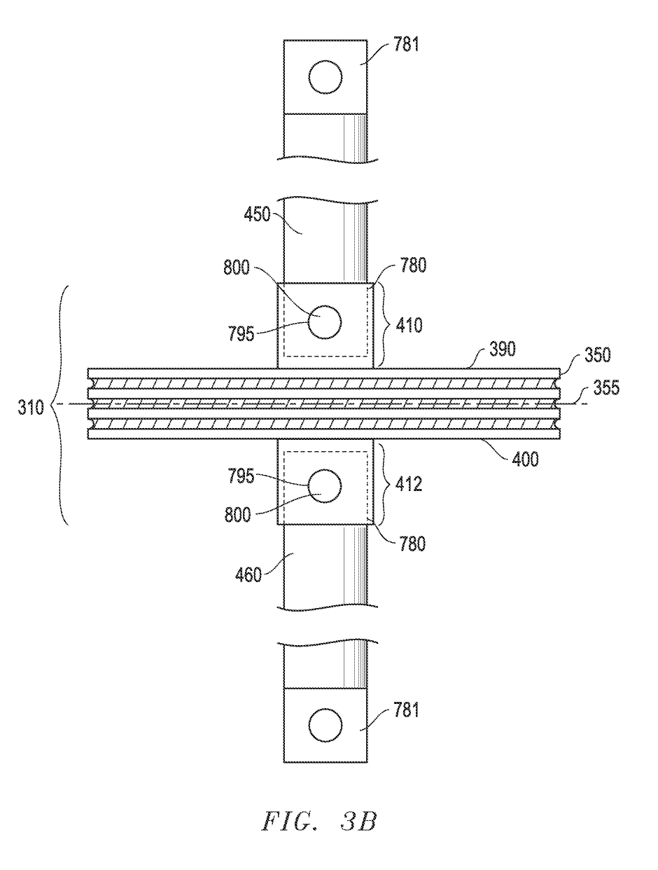

FIGS. 3a and 3b show a side view of the piston assembly 310 and detail its connection to the top piston rod 450 and bottom piston rod 460. The bushing 360 and piston seals 365 are not shown. FIG. 3b, depicts the piston assembly 310 as coupled to the top piston rod 450 and bottom piston rod 460 in a view rotated 90 degrees with respect to FIG. 3a. The top piston rod 450 attaches to the piston assembly 310 through a tongue 780, which is disposed in a lug groove 415, formed in the top lug portion 410. The tongue 780 has a thickness that is substantially the same as the lug groove 415 but allows the insertion of the tongue 780 within the lug groove 415. The top piston rod 450 also has a top tongue 781 on the opposite end such that the top piston rod 450 is substantially symmetric and to enable the upper portion of the top piston rod 450 to be coupled to the piston assembly 310. The lug groove 415, in conjunction with the piston thru hole 795, form the top lug portion 410. A piston rod thru hole 800 within the tongue 780 aligns with the piston thru hole 795 to allow a pin 805 to engage with the top lug portion 410 and tongue 780 to matingly couple the top piston rod 450 to the piston assembly 310. FIG. 3b shows the alignment of the piston thru hole 795, the piston rod thru hole 800. One end of the pin 805 passes through the piston thru hole 795 on one side of the top lug portion 410, through the piston rod thru hole 800 within the tongue 780, and through the piston thru hole 795 on the opposite side of the top lug portion 410. The pin 805 is long enough to traverse the entire thickness of the top lug portion 410 of the piston assembly 310 while at the same time allowing the piston assembly 310 to traverse freely within the hydraulic chamber 110. The bottom lug portion 412 is substantially similar in structure and function as the top lug portion 410 and couples to the bottom piston rod 460 in substantially the same manner in which the top lug portion 410 couples to the top piston rod 450.

The piston assembly 310 is substantially symmetric about a plane 355 that perpendicular to its engaging face 350. The plane 355 is depicted for reference purposes only as to the symmetrical design of the present embodiment and is not shown so as to represent a physical element of the piston assembly 310. Because the top piston rod 450 and the bottom piston rod 460 are substantially symmetric, the top piston rod 450 and the bottom piston rod 460 is rotatable and both ends of the top piston rod 450 and the bottom piston rod 460 can be interchangeably affixed to the piston assembly 310. Because the piston assembly 310 has substantially similar piston top surface 390 and piston bottom surface 400 wherein the top lug portion 410 and bottom lug portion 412 are substantially similar, the top piston rod 450 is interchangeable with the bottom piston rod 460. Thus, the bottom piston rod 460 can connect to the piston assembly 310 on the piston top surface 390 while the top piston rod 450 can connect to the piston assembly 310 on the piston bottom surface 400. Further, because the top end cap 120 is substantially similar to the bottom end cap 130, the top piston rod 450 can usably pass through the bottom end cap 130 while the bottom piston rod 460 can functionally pass through the top end cap 120. One of skill in the art will recognize that only a top piston rod 450 or a bottom piston rod 460 need be used with the hydraulic actuator assembly 100 in which case either the top piston rod 450 or bottom piston rod 460 can be used to connect to piston assembly 310 at the piston top surface 390 or the piston bottom surface 400. Because of its substantial symmetricity, the piston assembly 310 can be rotated in the hydraulic actuator assembly 100 so that the piston bottom surface 400 faces upwards while the piston top surface 390 faces downwards within the hydraulic chamber 110. Either one the top piston rod 450 or the bottom piston rod 460 can then couple to either the piston top surface 390 or the piston bottom surface 400 and pass through either the top end cap 120 or bottom end cap 130 which can be connected to either the top surface of the hydraulic chamber 110 or the bottom surface of the hydraulic chamber 110. In sum, the piston assembly 310 is rotatable within the hydraulic chamber 110 so that the piston assembly 310 does not have a preferred orientation within the hydraulic chamber 110. Thus, the top piston rod 450 and the bottom piston rod 460 are rotatable and interchangeable. The top end cap 120 and the bottom end cap 130 are interchangeable. Because the top mating connection 150 on the top end cap 120 is substantially similar to the bottom mating connection 160 on the bottom end cap 130, the hydraulic actuator assembly 100 is also rotatable in its external connections (not shown) and both ends can interchangeably couple to an external component (see FIG. 1 coupling connection 170).

One of skill in the art will recognize that this embodiment is not limited to any particular size and the size of the hydraulic actuator will depend upon the particular application and intended external components such as a gate valve, a plug valve, a choke, etc. Further one of skill in the art will recognize that the hydraulic actuator assembly 100 is not limited to any type of material. As a non-limiting example, the hydraulic actuator assembly 100 is formed primarily from low alloy steel; the seals can be formed from elastomeric material; and bushings can be formed from PTFE.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A hydraulic actuator apparatus comprising:
an actuator body having an axial sleeve bore, wherein the actuator body has a first end and a second end;
a piston operationally disposed within the axial sleeve bore, wherein the piston has a first piston surface and a second piston surface that are substantially identical in shape and configuration such that the piston can be configured within the axial sleeve bore with the first piston surface facing either the first end or the second end of the actuator body;
a first end cap having a first end cap hole defined therein, the first end cap being removably coupled to either the first end or second end of the actuator body;
a second end cap removably coupled to the actuator body on an end opposite of the first end cap; and
a piston rod disposed in the first chamber and having a piston rod end removably coupled to either the first piston surface or second piston surface wherein the piston rod slidably traverses through the first end cap hole.

2. The hydraulic actuator apparatus as in claim 1 wherein the second end cap has a second end cap hole through which the second piston rod slidably traverses and further comprising a second piston rod removably coupled to the first piston surface or the second piston surface depending on the installation position of the piston rod.

3. The hydraulic actuator apparatus as in claim 1 wherein the piston rod further comprises a second piston rod end wherein the second piston rod end can removably coupled to the first piston surface or the second piston surface depending on the installation position of the piston.

4. A hydraulic actuator apparatus comprising:
an actuator body having an axial sleeve bore, wherein the actuator body has a first end and a second end;
a piston operationally disposed within the axial sleeve bore, wherein the piston has a first piston surface, a second piston surface, and a piston engaging face wherein the piston engaging face is in cirumferential and contiguous engagement with the circumference of the axial sleeve bore to form a first chamber and a second chamber within the axial sleeve bore;
a first end cap having a first end cap hole defined therein, the first end cap being removably coupled to the first end of the actuator body;
a second end cap removably coupled to the second end of the actuator body; and
a piston rod disposed in the first chamber removably coupled to the first piston surface and slidably traversable through the first end cap hole, wherein the piston rod can be removed from the first chamber and decoupled from the first piston surface and placed within the second chamber and removably coupled to the second piston surface.

5. The hydraulic actuator apparatus as in claim 4 wherein the first end cap can be removed from the first end of the actuator body and removably coupled to the second end of the actuator body.

6. The hydraulic actuator apparatus as in claim 5 wherein the piston rod is removed from the first chamber and the first piston surface so that the piston rod is removably coupled to the second surface within the second chamber and slidably traversable through the first end cap hole of the first end cap.

7. The hydraulic actuator apparatus as in claim 4 wherein the first end cap and the second end cap is interchangeably coupled to the actuator body such that the first end cap of the actuator body is removably coupled to the second end of the actuator body and the second end cap can be removably coupled to the first end of the actuator body.

8. The hydraulic actuator apparatus as in claim 4 wherein the second end cap has a second end cap hole, and wherein the hydraulic actuator further comprises a second piston rod within the second chamber removably coupled to the second piston surface and slidably traversable through the second end cap hole, wherein the second piston rod can be interchanged with the piston rod so that the second piston rod is removably coupled to the first piston surface.

9. The hydraulic actuator apparatus as in claim 8 wherein the second piston rod can be interchanged with the piston rod so that the second piston rod is removably coupled to the first piston surface and slidably traversable through the first end cap hole of the first end cap and the piston rod is removably coupled to the second piston surface and slidably traversable through the second end cap hole of the second end cap.

10. The hydraulic actuator apparatus as in claim 4 wherein the second end cap has a second end cap hole and wherein the hydraulic actuator further comprises a second piston rod within the second chamber removably coupled to the second piston surface slidably traversable through the second end cap hole wherein the second piston rod can be interchanged with the piston rod and the second end cap can be interchanged with the first end cap so that the second end cap can be removably coupled to the first end of the actuator and the second piston rod can be removably coupled to the first piston surface and slidably traversable through the second end cap hole of the second end cap.

11. The hydraulic actuator apparatus as in claim 10 wherein upon interchanging the piston rod with the second piston rod and interchanging the first end cap with the second end cap, the piston rod can be removably coupled to the second piston surface and is slidably traversable through the first end cap removably coupled to the second end of the actuator.

12. A hydraulic actuator system comprising:
a hydraulic actuator apparatus comprising:
an actuator body having an axial sleeve bore, wherein the actuator body has a first end and a second end;
a first end cap having a first end cap hole defined therein and removably coupled to the first end of the actuator body;
a second end cap having a second end cap hole defined therein and removably coupled to the second end of the actuator body;
a piston operationally and removably disposed within the axial sleeve bore, wherein the piston has a first piston surface and a second piston surface, wherein the piston divides the axial sleeve bore into a first chamber and a second chamber;
a first piston rod removably coupled to the first piston surface and slidably traversable through the first end cap hole;
a second piston rod removably coupled to the second piston surface and slidably traversable through the second end cap hole; and
an external component removably coupled to the first end cap engaged with and removably coupled to the first piston rod, wherein the external component can be decoupled from the first end cap and first piston rod and removably coupled to the second end cap and removably coupled to the second piston rod.

13. The hydraulic actuator system as in claim 12 further comprising a second external component removably coupled to the second end cap and removably and engagingly coupled to the second piston rod of the hydraulic actuator wherein the first external component and the second external component can be interchanged so that the first external component can be removably coupled to the second end cap and removably and engagingly couples to the second piston rod and the second external component can be removably coupled to the first end cap and removably and engagingly couples to the first piston rod.

14. The hydraulic actuator system as in claim 12 further comprising a first port coupled to the first chamber and a second port coupled to the second chamber wherein the first port and the second port are symmetrically located on the actuator body.
